(19) United States
(12) Patent Application Publication
(10) Pub. No.: US 2024/0415263 A1
(43) Pub. Date: Dec. 19, 2024

(54) NAIL STICKER

(71) Applicant: GLLUGA INC., Chungcheongnam-do (KR)

(72) Inventors: Jun Gil UM, Gyeonggi-do (KR); Jae Bak AHN, Chungcheongbuk-do (KR); Hyo Sub KIM, Incheon (KR)

(21) Appl. No.: 18/701,692

(22) PCT Filed: May 18, 2023
(86) PCT No.: PCT/KR2023/006765

§ 371 Date: Apr. 16, 2024

(30) Foreign Application Priority Data
May 20, 2022 (KR) 10-2022-0062244
Sep. 21, 2022 (KR) 10-2022-0119369

(51) Int. Cl. A45D 29/00; A45D 31/00; C09D 101/14; C09J 7/22

(52) U.S. Cl. CPC A45D 29/001; A45D 31/00; C09D 101/14; C09J 7/22; C09J 2401/00

(57) ABSTRACT

The present invention relates to a nail sticker and the nail sticker is a curable nail sticker. The nail sticker includes a soft layer, the soft layer includes a resin for the soft layer, and the resin for the soft layer may include at least one of cellulose acetate butyrate and cellulose acetate propionate.

### TECHNICAL FIELD

The present invention relates to a curable nail sticker which includes a soft layer.

### BACKGROUND ART

As one of the ways to express physical beauty pursued by humans, the beauty industry is developing at an accelerating pace and is being subdivided simultaneously. Specifically, with the rapid expansion of the market since the 20th century, the beauty industry began to become popular among the ordinary people. In the beauty industry, the nail art is an essential element of expressive art for a body regardless of age group and gender and has been rapidly developing in recent years.

Originally, the nail art is one of the ways for beautifully decorating the human body as a field of beauty art. A length, a shape, or a color of a nail has been expressed to reflect cultural changes and values of the times.

In the nail art, a nail sticker with a shape of fingernail or toenail which is artificially manufactured is used by many people. In the past, the nail stickers was manufactured in a curved shape, like a fingernail or toenail shape, to be supplied to consumers. However, each people has a different fingernail or toenail shape (in particular, a curvature radius) so that there is a problem in that it is difficult to closely adhere the nail sticker which already had a curved shape to the consumer's fingernail or toenail.

In order to solve this problem, a nail sticker including a ultraviolet curing raw material has recently been in the spotlight. Specifically, the consumers deform the nail sticker to fit their fingernail or toenail and then irradiate the ultraviolet ray to cure the nail sticker. Therefore, the user's fingernail or toenail and the nail sticker can be closely adhered so that the adhesive strength of the nail sticker is improved. Such a nail sticker is also referred to as a gel nail sticker.

In the meantime, during a process of using a UV curable nail sticker, an attached shape of the nail sticker may vary depending on fingernail or toenail shapes of consumers. However, referring to FIG. 1, when a fingernail or toenail 2 on a finger 3 is curved with a sharp curve (small curvature radius), the nail sticker is well attached to the fingernail or toenail in an area 2a close to a cuticle of an upper surface area of the fingernail or toenail. However, in an area near the tip of the fingernail or toenail (an area close to a free edge, 2b), the nail sticker is not attached to the fingernail or toenail, but is lifted (e). When the nail sticker and the fingernail or toenail are not smoothly attached, but are lifted off, foreign materials are easily located in the lifted area so that the nail sticker is contaminated, the consumer feels a foreign body sensation, and the adhesive strength of the nail sticker is lowered.

Further, in some cases, as illustrated in FIG. 2, when the nail sticker is attached to the fingernail and then cured, the nail sticker is excessively bent (f) to deteriorate the appearance of the nail sticker.

Further, as illustrated in FIG. 3, when the surface of the fingernail or toenail is excessively uneven, if the nail sticker is attached, the surface of the nail sticker becomes excessively uneven along the surface of the fingernail or toenail.

Therefore, a new nail sticker is required to minimize the lifting phenomenon of the nail sticker and to smooth the surface of the nail sticker.

### RELATED ART DOCUMENT

### [Patent Document]

(Patent Document 1) Korean Unexamined Patent Application Publication No. 10-2019-0014044

### DISCLOSURE

### Technical Problem

One object to be achieved by the present invention is to provide a nail sticker which minimizes a lifting phenomenon between the nail sticker and the fingernail (or toenail) to minimize contamination of the nail sticker and allow a user to feel less foreign body sensation.

Further, another object to be achieved by the present invention is to provide a nail sticker which minimizes a shape of the nail sticker from being excessively deformed.

Further, still another object to be achieved by the present invention is to provide a nail sticker which has a smooth surface of the attached nail sticker even though the surface of the fingernail or toenail has irregularities.

### Technical Solution

According to an exemplary embodiment of the present invention, a curable nail sticker includes a soft layer, the soft layer includes a resin for the soft layer, and the resin for the soft layer includes at least one of cellulose acetate butyrate and cellulose acetate propionate.

According to another exemplary embodiment of the present invention, a curable nail sticker includes a soft layer, a maximum thickness of the soft layer is increased when a pressure is applied to a part of an upper surface of the nail sticker after attaching the nail sticker on a flat floor.

According to still another exemplary embodiment of the present invention, a curable nail sticker includes a soft layer, wherein a maximum thickness of the nail sticker is increased when a pressure is applied to a part of an upper surface of the nail sticker after attaching the nail sticker on a flat floor.

According to still another exemplary embodiment of the present invention, a curable nail sticker includes a soft layer, a rectangular parallelepiped substrate with a thickness of 0.7 mm disposed on a flat floor is prepared and the nail sticker is attached on an upper surface such that an area having a length corresponding to 70% the entire length of the nail sticker is in contact with the flat upper surface of the substrate and when measuring after a force of 38.5 N is applied to at least a part of the upper surface of the nail sticker which overlaps the substrate in a vertical direction toward a floor, the force is removed and then the nail sticker is left for 30 minutes at 36° C., a shortest distance between an area where a part of the nail sticker which does not overlap the substrate in the vertical direction and protrudes out of the substrate is in contact with the floor and the substrate is 1.5 mm or less. The force is applied to an area corresponding to 40% to 80% the entire area of the upper surface of the nail sticker.

### Advantageous Effects

According to the present invention, during a process of attaching the nail sticker by a user, a thickness of the soft layer adjacent to a tip of the nail (fingernail or toenail) is increased. Accordingly, the soft layer may efficiently fill the space between the nail sticker and the nail (fingernail or toenail) to minimize the lifting phenomenon of the nail sticker. Accordingly, the contamination of the nail sticker due to the foreign material is reduced, the user may feel less foreign body sensation, and the adhesive strength of the nail sticker is further improved.

Further, excessive deformation of the nail sticker is suppressed by the soft layer.

Further, even though the surface of the fingernail or toenail has irregularities, the surface of the attached nail sticker has a smooth shape, which improves aesthetics.

### DESCRIPTION OF DRAWINGS

FIG. 1 is a cross-sectional view illustrating a shape of a nail sticker of the related art which is worn on a nail.

FIG. 2 is a cross-sectional view illustrating a shape of a nail sticker of the related art which is worn on a nail.

FIG. 3 is a cross-sectional view illustrating a shape of a nail sticker of the related art which is worn on a nail.

FIG. 4 is a plan view (top view) of a nail sticker according to an exemplary embodiment of the present invention.

FIG. 5 is a cross-sectional view of a part of a nail sticker according to an exemplary embodiment of the present invention.

FIG. 6 is a cross-sectional view of a part of a nail sticker according to an exemplary embodiment of the present invention.

FIG. 7 is a cross-sectional view of a nail sticker according to an exemplary embodiment of the present invention which is placed on a flat floor.

FIG. 8 is a cross-sectional view when a pressure is applied to a nail sticker according to an exemplary embodiment of the present invention.

FIG. 9 is a cross-sectional view when after applying a pressure to a nail sticker according to an exemplary embodiment of the present invention, the pressure is removed and then the nail sticker is left for 30 minutes.

FIG. 10 is a cross-sectional view illustrating a shape of a nail sticker to which a pressure is applied, after attaching the nail sticker according to an exemplary embodiment of the present invention to a nail.

FIG. 11 is a cross-sectional view illustrating a shape of a nail sticker to which a pressure is applied, after attaching the nail sticker according to an exemplary embodiment of the present invention to a nail.

FIG. 12 is a cross-sectional view for explaining a physical property of a nail sticker according to an exemplary embodiment of the present invention.

FIG. 13 is a photograph of a state in which a nail sticker of Example 1 is not attached to a nail (no pressure is applied).

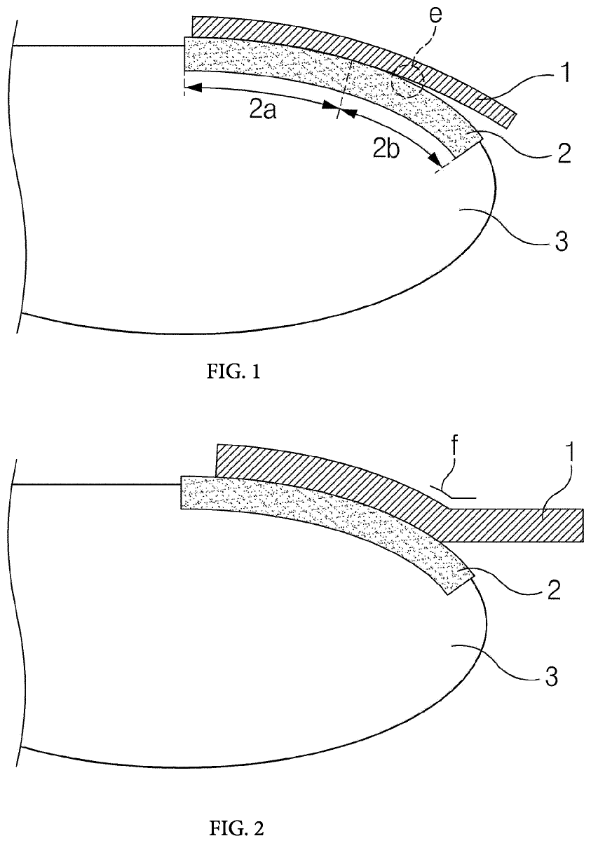

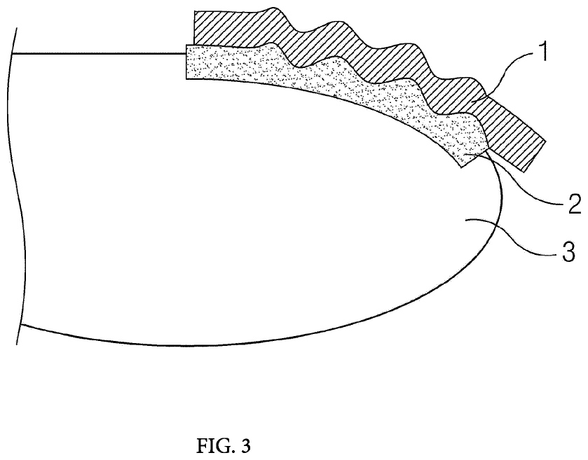

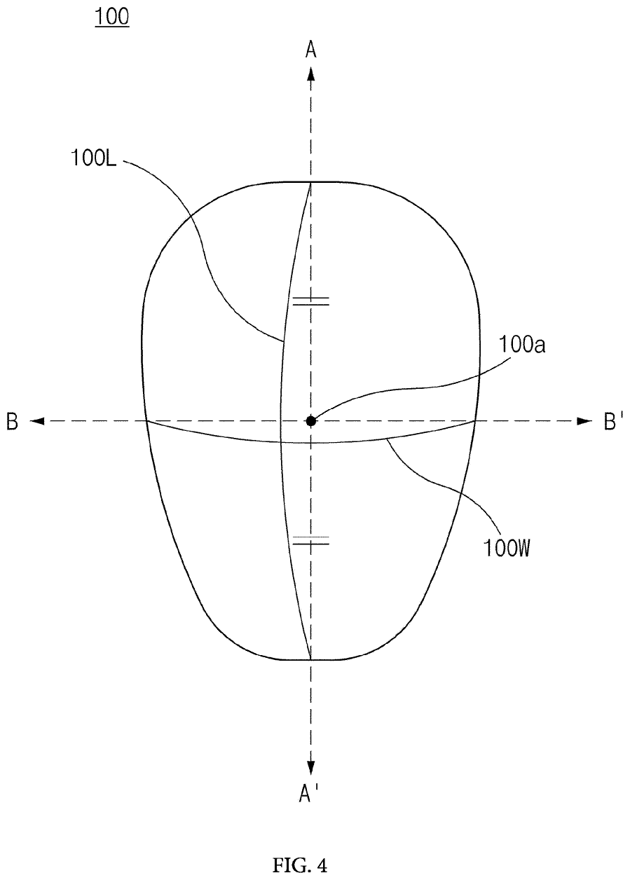

FIG. 4 is a photograph of a state in which after applying a pressure to a nail sticker of Example 1 for several seconds, the pressure is removed and the nail sticker is left for a predetermined time.

FIG. 15 is a photograph of a state in which a nail sticker of Comparative Example 1 is not attached to a nail (no pressure is applied).

FIG. 4 is a photograph of a state in which after applying a pressure to a nail sticker of Comparative Example 1 for several seconds, the pressure is removed and the nail sticker is left for a predetermined time.

FIG. 17 is a photograph of a nail sticker according to Example 1 which is worn on a nail.

FIG. 18 is a photograph of a nail sticker according to Comparative Example 1 which is worn on a nail.

FIG. 19 is a photograph of confirming a cross section of a nail sticker after wearing a nail sticker according to Example 1 on a nail.

FIG. 20 is a photograph of confirming a cross section of a nail sticker after wearing a nail sticker according to Comparative Example 1 on a nail.

FIG. 21 is a photograph obtained by capturing a lower surface of a nail sticker according to Example 1 which is worn on a nail and then removed from the nail.

FIG. 22 is a photograph obtained by capturing a lower surface of a nail sticker according to Comparative Example 1 which is worn on a nail and then removed from the nail.

FIG. 23 is a photograph of a fingernail with a severe ridge on a surface.

FIG. 24 is a photograph of a nail sticker according to Example 1 which is worn on a nail of FIG. 23.

FIG. 25 is a photograph of a nail sticker according to Comparative Example 1 which is worn on a nail of FIG. 23.

FIG. 26 is a photograph obtained by capturing a lower surface of a nail sticker according to Example 1 which is worn on a nail and then removed from the nail of FIG. 23.

FIG. 27 is a photograph obtained by capturing a lower surface of a nail sticker according to Comparative Example 1 which is worn on a nail and then removed from the nail of FIG. 23.

FIG. 28 is a cross-sectional photograph illustrating an aspect of a nail sticker of Example 1 which is deformed by an external pressure.

FIG. 29 is a cross-sectional photograph illustrating an aspect of a nail sticker of Comparative Example 1 which is deformed by an external pressure.

FIG. 30 is a view for explaining a shape of applying a pressure to a nail sticker according to an exemplary embodiment of the present invention.

### MODE FOR CARRYING OUT THE DISCLOSURE

Those skilled in the art may make various modifications to the present invention and the present invention may have various embodiments thereof, and thus specific embodiments will be illustrated in the drawings and described in detail in detailed description.

However, this does not limit the present invention within specific exemplary embodiments, and it should be understood that the present invention covers all the modifications, equivalents and replacements within the spirit and technical scope of the present invention. In describing the present disclosure, when it is determined that a detailed description of related well-known technology may obscure the gist of the present disclosure, the detailed description thereof will be omitted.

Terms used in the present application are used only to describe a specific exemplary embodiment, but are not intended to limit the present invention. A singular form may include a plural form if there is no clearly opposite meaning in the context.

In the present invention, it should be understood that term “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance.

In the present invention, being disposed or located “on” may mean not only being present on the subject in a directly abutting state, but also being disposed or located on top of the subject in a spaced state.

In the present specification, a nail refers to a fingernail and/or toenail.

A thickness to be measured in the present invention is confirmed by equipment of VHX-970F available from Keyence.

In the specification, a “maximum thickness” of any configuration refers to the largest thickness, among thicknesses of the configuration measured along a vertical direction from an arbitrary point of a lower surface of the configuration. A point with the maximum thickness before applying a pressure and a point with the maximum thickness when the pressure is removed after applying the pressure may be the same or different.

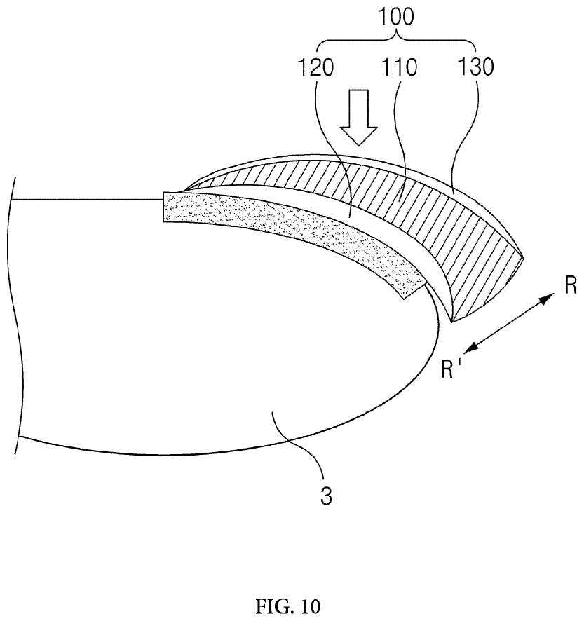

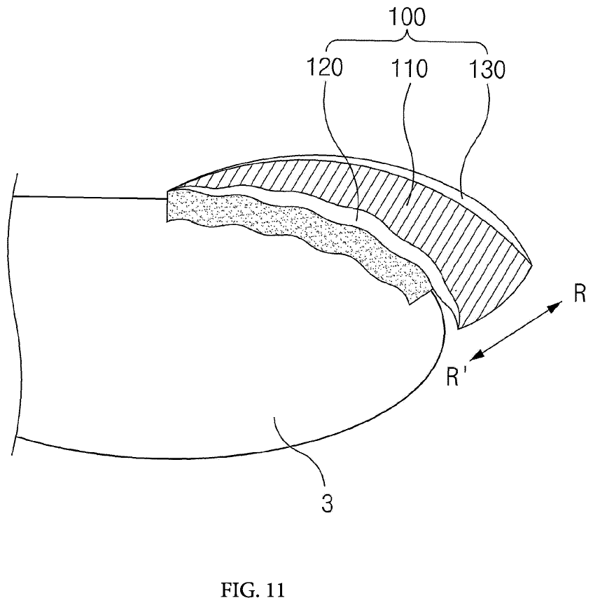

In the specification, when it is assumed that a R direction of FIGS. 7 to 11 is an upper direction, an upper surface of the nail sticker indicates a surface exposed toward the upper direction. Specifically, the upper surface of the nail sticker may be a surface through which a coating layer is exposed to the outside. In the specification, when it is assumed that a R′ direction of FIGS. 7 to 11 is a lower direction, a lower surface of the nail sticker indicates a surface exposed toward the lower direction. Specifically, the upper surface of the nail sticker may be a surface through which a base layer (specifically, an adhesive layer of the base layer) is exposed to the outside.

Referring to FIG. 4, the nail sticker includes a long axis and a short axis. The long axis corresponds to an axis including an imaginary line segment corresponding to the longest length of the nail sticker, in a direction from a root of the nail to a distal end (a distal end adjacent to an ending point of the finger) of the nail when the nail sticker is worn on the nail (A-A′ of FIG. 4). Here, a length 100L of the nail sticker refers to a size of the nail sticker in a direction from a nail root to a distal end (a distal end adjacent to an ending point of the finger) of the nail when the nail sticker is worn on the nail and the length direction of the nail sticker is parallel to the long axis. The short axis is an imaginary line segment which is perpendicular to the long axis and a width 100W of the nail sticker is parallel to the short axis of the nail sticker. A center 100a of the nail sticker refers to a point at which the longest length of th lengths of the nail sticker is divided into two parts.

In the present specification, “applying a pressure” to explain a physical property of the nail sticker means applying a force of 38.5 N to an upper surface of the nail sticker in an atmosphere of a temperature of 36° C. The pressure is applied using push gage equipment of IMADA Inc. and a pressure value is measured. An area of the lower surface of a member which applies the pressure may be for example, 177 mm², but is not limited thereto. Further, the pressure is not applied to 1) a point where the soft layer has the maximum thickness before applying a pressure and 2) a point where the nail sticker has the maximum thickness before applying a pressure. Specifically, when the pressure is applied, a force of 38.5 N is downwardly applied to an area with a size corresponding to 40% to 80% of the entire size of the upper surface of the nail sticker in the atmosphere of a temperature of 36° C.

### <Nail Sticker>

The nail sticker refers to an artificial laminated structure which is manufactured to be attached on a nail (fingernail and/or toenail). In consideration of the purpose of attachment, it is also referred to as a nail art or a nail art sticker. Specifically, when a consumer is supplied with the nail sticker, the consumer attaches the nail art to the nail while deforming a shape of the nail sticker to be adhered onto the nail and then irradiates the ultraviolet to cure the nail sticker.

A nail sticker according to the exemplary embodiment of the present invention includes a curable soft layer. The soft layer includes a resin for the soft layer and the resin for the soft layer includes at least any one of cellulose acetate butyrate and cellulose acetate propionate.

When a curable nail sticker of the related art is used, if the nail is curved with a sharp curve (a small curvature radius), the nail sticker is well attached to the nail in an area close to a cuticle of an upper surface area of the nail. However, in an area near the tip of the nail (an area close to a free edge), the nail sticker is not attached to the nail, but is lifted off. When the nail sticker and the nail are not smoothly attached, but are lifted off, foreign materials are easily located in the lifting area so that the nail sticker is contaminated, the consumer feels a foreign body sensation, and the adhesive strength of the nail sticker is lowered.

In order to solve this problem, after a lot of effort of researches, a soft layer is included in a nail sticker. The soft layer has appropriate storage and loss moduli at a body temperature so that when a user applies a predetermined force during a process of attaching the nail sticker, the soft layer is easily deformed by the body temperature and the deformed shape is maintained. Therefore, the soft layer fills a space between the nail (or toenail) and the nail sticker and the filled state is maintained. Accordingly, the contamination of the nail sticker due to the foreign material is reduced, the user may feel less foreign body sensation, and the adhesive strength of the nail sticker is further improved. Further, when a part of the nail sticker extends beyond a nail area, the soft layer may serve to support the part of the nail sticker which extends and protrudes so as not to be deformed. Further, even though the nail surface has irregularities, the surface of the attached nail sticker has a smooth shape, which improves aesthetics.

Hereinafter, this will be described in more detail below.

The soft layer includes a resin for the soft layer. The resin for the soft layer may include at least one of cellulose acetate butyrate and cellulose acetate propionate. Accordingly, when the user applies a predetermined force during a process of attaching the nail sticker, the soft layer fills a space floated between the nail and the nail sticker and the filled state is effectively maintained. Accordingly, the user will feel less a foreign body sensation and the adhesive strength of the nail sticker is increased. Further, when a part of the nail sticker extends beyond a nail area, the soft layer may serve to support the part of the nail sticker which extends and protrudes so as not to be deformed. Further, even though a nail surface has irregularities, more soft layer may be disposed on a recessed portion of the nail surface by applying a predetermined force. Accordingly, even though the nail surface has irregularities, the surface of the attached nail sticker has a smooth shape, which improves aesthetics. Moreover, cellulose acetate butyrate and cellulose acetate propionate have superior shock absorption advantages to other materials.

To be more specific, the resin for the soft layer includes cellulose acetate butyrate and for example, the resin for the soft layer may be cellulose acetate butyrate. In this case, a shock absorption ability and durability are excellent. Further, when the resin is mixed with a UV curing material for the soft layer, ductility is increased so that the deformation of the soft layer due to the external impact appears irreversible by the effect of shock absorption ability. The deformed shape may be more easily maintained.

The resin for the soft layer is included in the soft layer in an amount of 10 wt % to 90 wt %, and particularly, 15 wt % to 75 wt %, and more particularly, 30 wt % to 65 wt %. When the above range is satisfied, the soft layer is easily deformed in the level of a body temperature and the deformed shape of the soft layer may be maintained.

The soft layer further includes a ultraviolet curing material for the soft layer. Therefore, the soft layer may be cured by irradiating the ultraviolet ray.

A ultraviolet curing material for the soft layer includes at least one selected from a group consisting of urethane acrylate-based oligomer, polyester acrylate-based oligomer, polyether acrylate-based oligomer, epoxy acrylate-based oligomer, polycarbonate acrylate-based oligomer, silicone acrylate-based oligomer, and acrylic acrylate-based oligomer.

Specifically, the ultraviolet curing material for the soft layer includes urethane acrylate-based oligomer, polyester acrylate-based oligomer, and epoxy acrylate-based oligomer.

Advantageously, the urethane acrylate-based oligomer is easily cured by the ultraviolet ray and also has a predetermined flexible physical property even after being cured. Further, haze phenomenon is minimized so that the transparency of a coating layer is maintained. The urethane acrylate-based oligomer may include at least one of a bi-functional urethane acrylate-based oligomer, a tetra-functional urethane acrylate-based oligomer, a hexa-functional urethane acrylate-based oligomer, and a nine-functional urethane acrylate-based oligomer. Specifically, the urethane acrylate-based oligomer includes at least one selected from a group of PU210, PU280, PU640, SC2404 manufactured by Miwon Specialty Chemical Co., Ltd., CN9033 and CN9047 manufactured by SATOMER. A weight average molecular weight of the urethane acrylate-based oligomer may be 1000 g/mol to 1000000 g/mol, and specifically, 1000 g/mol to 100000 g/mol. The above-mentioned range is satisfied, the workability may be significantly improved.

The epoxy acrylate-based oligomer has high reactivity, high hardness, and good polishability, and easy to be cured, has excellent flexibility, and stably cured even in contact with oxygen. The epoxy acrylate-based oligomer has one or two functional groups and shows ductility with one functional group. The higher the number of functional groups, the more advantageous for rigidity or thermal stability. Specifically, the epoxy acrylate-based oligomer may include at least any one selected from a group consisting of PE210, PE2120, and PE250 manufactured by Miwon Specialty Chemical Co., Ltd. A weight average molecular weight of the epoxy acrylate-based oligomer may be 100 g/mol to 10000 g/mol, and specifically, 500 g/mol to 6000 g/mol. In consideration of a solid content and viscosity of the composition for forming a soft layer, the above-mentioned range is desirable.

The polyester acrylate-based oligomer has excellent reactivity and has better adhesive strength than the urethane acrylate-based oligomer and epoxy acrylate-based oligomer. The polyester acrylate-based oligomer may be an oligomer having four or six functional groups. Specifically, the polyester acrylate-based oligomer includes at least any one selected from a group consisting of PS4040, PS460, PS6300, Etermer 6311-100, 6312-100, 6314C-60 which are products of Miwon Specialty Chemical Co., Ltd. A weight average molecular weight of the polyester acrylate-based oligomer may be 500 g/mol to 50000 g/mol, and specifically, 1500 g/mol to 38000 g/mol. The above-mentioned range is satisfied, the processability and the adhesive strength may be improved.

In the soft layer, the epoxy acrylate-based oligomer may be included in an amount of 1 to 10 parts by weight based on 100 parts by weight of the urethane acrylate-based oligomer, and specifically, included in an amount of 1 to 3 parts by weight. In the soft layer, the polyester acrylate-based oligomer may be included in an amount of 10 to 20 parts by weight based on 100 parts by weight of the urethane acrylate-based oligomer, and specifically, included in an amount of 2 to 8 parts by weight. When the above composition is satisfied, even though the soft layer is exposed to the air, the soft layer is not rapidly cured and the durability may be maintained even after the nail sticker is attached.

In contrast, the ultraviolet curing material for the soft layer includes the urethane acrylate-based oligomer and specifically, is formed of the urethane acrylate-based oligomer.

The ultraviolet curing material for the soft layer is included in the soft layer in an amount of 10 wt % to 90 wt %, and specifically, 15 wt % to 75 wt %, and more specifically, 30 wt % to 65 wt %. When the above range is satisfied, the soft layer maintains a flexible property before irradiating ultraviolet ray and then becomes very hard after being cured by irradiating ultraviolet ray.

In the soft layer, the weight ratio of the ultraviolet curing material for the soft layer and the resin for the soft layer may be 10:90 to 90:10, specifically 20:80 to 80:20, more specifically 30:70 to 70:30. When the above-mentioned range is satisfied, a shock absorption property of the resin for the soft layer and the viscosity of the ultraviolet curing material for the soft layer are mixed to further increase an external striking energy absorption ability.

A photoinitiator for the soft layer serves to initiate polymerization reaction by irradiating ultraviolet ray. Specifically, the photoinitiator may be a UV photoinitiator.

The photoinitiator for the soft layer has an absorption wavelength band in the range of 200 nm to 600 nm.

The photoinitiator for the soft layer includes at least any one selected from a group of trimethylbenzoyl phosphnie oxide, phenylbis(2,4,6-trimethylbenzoyl)phosphine oxide, and 2-benzyl-2-(dimethylamino)-1-[4-(4-morpholinyl)phenyl]-1-butanone, but is not necessarily limited thereto.

The photoinitiator for the soft layer is included in the soft layer in an amount of 1 wt % to 10 wt %, and specifically, 1 wt % to 8 wt %, and more specifically, 2 wt % to 7 wt %. If the above-mentioned range is satisfied, when the user cures the nail sticker, the nail sticker may have an appropriate hardness.

A maximum thickness of the soft layer may be 250 μm to 2500 μm, and particularly, 500 μm to 2400 μm, and more particularly, 600 μm to 2000 μm, and for example, 1000 μm to 2000 μm. Further, when the above-mentioned range is satisfied, a sufficient amount of a part of the soft layer may move to minimize a lifting phenomenon between the nail sticker and the nail. Further, when a part of the nail sticker extends beyond the nail area, the soft layer may more effectively serve to support the part of the nail sticker which extends and protrudes so as not to be deformed. Further, even though the nail surface has irregularities, more soft layer may be sufficiently located on the recessed portion of the nail by the movement of the soft layer so that the surface of the attached nail sticker may have more smooth shape. Further, a deformation rate of the soft layer is not high due to the external shock so that the above-described effects may be smoothly maintained. The maximum thickness of the soft layer refers to the largest thickness of the thicknesses of the soft layer measured vertically from an arbitrary point of the lower surface of the soft layer.

The soft layer may be a single layer or may be formed of two or more layers.

The nail sticker further includes a base layer. The soft layer is disposed on the base layer.

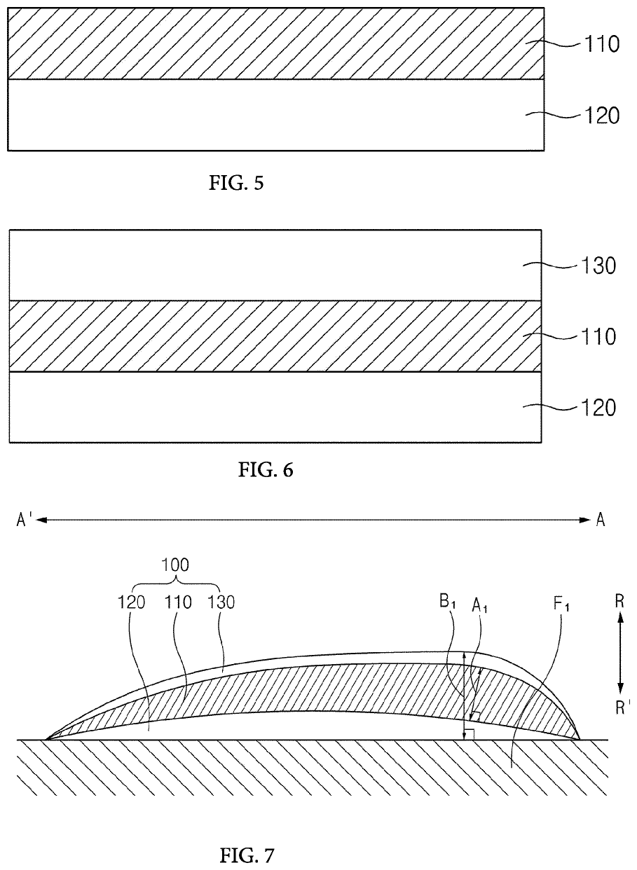

Referring to FIGS. 5 to 11, an upper surface of the base layer 120 and the lower surface of the soft layer 110 may be opposite to each other and specifically, are in contact with each other. That is, the soft layer 110 may be located on the base layer 120.

The base layer includes an adhesive layer. The adhesive layer imparts a chemical adhesive strength to allow the nail sticker to be attached on the nail. Therefore, the adhesive layer may configure the lowest surface of the nail sticker. The lower surface of the nail sticker of the present invention may be flat and this means that the lower surface of the adhesive layer is flat. The adhesive layer includes an adhesive component which may correspond to an adhesive component commonly used in the field.

The base layer further includes a design layer. The design layer is located between the adhesive layer and the soft layer. The design layer includes at least any one of a color layer and a printed layer. The design layer may include a pigment which gives colors to the nail sticker. The printed layer includes various materials for aesthetics, such as particles and talc for pattern expression.

A base film is disposed on the lower surface of the base layer. The base film serves to maintain the adhesiveness before using the nail sticker by preventing the contamination of the adhesive layer and is removed when the nail sticker is used. The base film may include a component which is commonly used in the field.

The nail sticker further includes a coating layer.

Referring to FIGS. 5 to 11, the coating layer 130 is located on the soft layer 110 in the nail sticker 100.

The coating layer includes an ultraviolet curing material for a coating layer and a resin for a coating layer.

As the ultraviolet curing material for a coating layer is included in the coating layer, the user modifies the nail sticker to be closely adhered with the user's nail, and then irradiates the ultraviolet ray to cure the nail sticker with a deformed shape of the nail sticker. Therefore, the nail sticker and the fingernail/toenail can be bonded to each other in complete contact so that the nail sticker adhesive strength may be improved.

A ultraviolet curing material for the coating layer includes at least one selected from a group consisting of urethane acrylate-based oligomer, polyester acrylate-based oligomer, polyether acrylate-based oligomer, epoxy acrylate-based oligomer, polycarbonate acrylate-based oligomer, silicone acrylate-based oligomer, and acrylic acrylate-based oligomer.

Specifically, the ultraviolet curing material for the coating layer includes urethane acrylate-based oligomer, polyester acrylate-based oligomer, and epoxy acrylate-based oligomer.

Advantageously, the urethane acrylate-based oligomer is easily cured by the ultraviolet ray and also has a predetermined flexible physical property even after being cured. Further, haze phenomenon is minimized so that the transparency of a coating layer is maintained. The urethane acrylate-based oligomer may include at least one of a bi-functional urethane acrylate-based oligomer, a tetra-functional urethane acrylate-based oligomer, a hexa-functional urethane acrylate-based oligomer, and a nine-functional urethane acrylate-based oligomer. Specifically, the urethane acrylate-based oligomer includes at least one selected from a group of PU210, PU280, PU640, SC2404 manufactured by Miwon Specialty Chemical Co., Ltd., CN9033 and CN9047 manufactured by SATOMER. A weight average molecular weight of the urethane acrylate-based oligomer may be 1000 g/mol to 1000000 g/mol, and specifically, 1000 g/mol to 100000 g/mol. The above-mentioned range is satisfied, the workability may be significantly improved.

The epoxy acrylate-based oligomer has high reactivity, high hardness, and good polishability, and easy to be cured, has excellent flexibility, and stably cured even in contact with oxygen. The epoxy acrylate-based oligomer has one or two functional groups and shows ductility with one functional group. The higher the number of functional groups, the more advantageous for rigidity or thermal stability. Specifically, the epoxy acrylate-based oligomer may include at least any one selected from a group consisting of PE210, PE2120, and PE250 manufactured by Miwon Specialty Chemical Co., Ltd. A weight average molecular weight of the epoxy acrylate-based oligomer may be 100 g/mol to 10000 g/mol, and specifically, 500 g/mol to 6000 g/mol. In consideration of a solid content and viscosity of the composition for forming a coating layer, the above-mentioned range is desirable.

The polyester acrylate-based oligomer has excellent reactivity and has better adhesive strength than the urethane acrylate-based oligomer and epoxy acrylate-based oligomer. The polyester acrylate-based oligomer may be an oligomer having four or six functional groups. Specifically, the polyester acrylate-based oligomer includes at least any one selected from a group consisting of PS4040, PS460, PS6300, Etermer 6311-100, 6312-100, 6314C-60 which are products of Miwon Specialty Chemical Co., Ltd. A weight average molecular weight of the polyester acrylate-based oligomer may be 500 g/mol to 50000 g/mol, and specifically, 1500 g/mol to 38000 g/mol. The above-mentioned range is satisfied, the processability and the adhesive strength may be improved.

In the coating layer, the epoxy acrylate-based oligomer may be included in an amount of 1 to 10 parts by weight based on 100 parts by weight of the urethane acrylate-based oligomer, and specifically, included in an amount of 1 to 3 parts by weight. In the coating layer, the polyester acrylate-based oligomer may be included in an amount of 10 to 20 parts by weight based on 100 parts by weight of the urethane acrylate-based oligomer, and specifically, included in an amount of 2 to 8 parts by weight. When the above composition is satisfied, even though the coating layer is exposed in the air, the soft layer is not rapidly cured and the durability may be maintained even after the nail sticker is attached.

In contrast, the ultraviolet curing material for the coating layer includes the urethane acrylate-based oligomer and specifically, is formed of the urethane acrylate-based oligomer.

The ultraviolet curing material for the coating layer is included in the coating layer in an amount of 10 wt % to 90 wt %, and specifically, 10 wt % to 60 wt %, and more specifically, 20 wt % to 50 wt %. When the above range is satisfied, the coating layer maintains a flexible property before irradiating ultraviolet ray and then becomes very hard after being cured by irradiating ultraviolet ray.

The resin for a coating layer serves to maintain a shape by controlling a flowability of the coating layer. Further, the resin for a coating layer allows a composition for forming the coating layer to have an appropriate viscosity so that the coating layer may be manufactured in a desired shape.

The resin for the coating layer may be a thermoplastic resin for the coating layer having a glass transition temperature (Tg) of 30° C. to 200° C., and specifically 50° C. to 120° C. When the above-mentioned range is satisfied, the mobility of the resin for the coating layer is not high at room temperature, but during the manufacturing process of the nail sticker, the resin for the coating layer is properly mixed with the UV curing material in a drying furnace, so that the side lines of the nail sticker are smoothly formed.

The resin for the coating layer may include at least any one selected from the group consisting of an acrylic resin for a coating layer, a nitrocellulose resin for a coating layer, an epoxy resin for a coating layer, a polyester resin for a coating layer, a polyvinyl resin for a coating layer, a urethane resin for a coating layer, and a vinyl acetate resin for a coating layer.

Particularly, the resin for the coating layer includes an acrylic resin for a coating layer and a nitrocellulose resin for a coating layer. A glass transition temperature (Tg) of the acrylic resin for the coating layer may be 30° C. to 200° C., and specifically 50° C. to 120° C. The nitrocellulose resin for a coating layer includes HRS 1/8 to 20 SS type 1/8 to 1/2 of Korea CNC Ltd. A nitrogen content of the nitrocellulose resin for a coating layer may be 11.5% to 12.2%, and specifically, divided into ⅛ seconds to 20 seconds depending on a viscosity. When the above-mentioned range is maintained, the low viscosity can be maintained to increase a solid content.

The resin for the coating layer is included in the coating layer in an amount of 10 wt % to 90 wt %, and specifically, 15 wt % to 75 wt %, and more specifically, 15 wt % to 65 wt %. When the above-mentioned range is satisfied, the stickiness disappears so that there is no problem even in handling at room temperature and a round shape may be formed.

In the meantime, the resin for the coating layer includes a thermosetting resin for a coating layer and a thermal initiator.

The coating layer further includes a photoinitiator for the coating layer.

The photoinitiator serves to initiate polymerization reaction by irradiating the ultraviolet ray. Specifically, the photoinitiator may be a UV photoinitiator.

The photoinitiator for the coating layer has an absorption wavelength band in the range of 200 nm to 600 nm.

The photoinitiator for the coating layer includes at least any one selected from a group of trimethylbenzoyl phosphnie oxide, phenylbis(2,4,6-trimethylbenzoyl)phosphine oxide, and 2-benzyl-2-(dimethylamino)-1-[4-(4-morpholinyl)phenyl]-1-butanone, but is not necessarily limited thereto.

The photoinitiator for the coating layer is included in the coating layer in an amount of 1 wt % to 10 wt %, and specifically, 1 wt % to 8 wt %, and more specifically, 2 wt % to 7 wt %. If the above-mentioned range is satisfied, when the user cures the coating layer, the coating layer may have an appropriate hardness.

In some cases, the coating layer includes a solvent. The solvent corresponds to a solvent used to form a composition for forming a coating layer to manufacture the coating layer and is dried to be removed during the manufacturing process of the coating layer. However, some solvent remains at a very low content in the coating layer.

The nail sticker further includes a design expression layer disposed on the coating layer. The design expression layer may show expressions such as matte and also show three-dimensional lines or a thick film type three-dimensional figure, such as a cone or a circular dome.

A maximum thickness of the nail sticker may be 300 μm to 3000 μm, and particularly, 600 μm to 2800 μm, and more particularly, 700 μm to 2600 μm. When the above-mentioned range is satisfied, the soft layer has obvious effect.

The nail sticker according to another exemplary embodiment of the present invention is a curable sticker and the nail sticker includes a soft layer. When the nail sticker is attached to a flat bottom and then a pressure is applied to a part of the upper surface of the nail sticker, the maximum thickness of the soft layer is increased. Here, the nail sticker is the same as the above-described nail sticker. The soft layer, the coating layer, and the base layer of the above-described nail sticker may be included in the nail sticker of this exemplary embodiment in the same way.

When the pressure is applied, a force of 38.5 N is applied to the upper surface of the nail sticker in the atmosphere of a temperature of 36° C. The pressure is applied using push gage equipment of IMADA Inc. and a pressure value is measured. An area of the lower surface of the member which applies the pressure may be for example, 177 mm², but is not limited thereto. Further, the pressure is not applied to 1) a point where the soft layer has the maximum thickness before applying a pressure and 2) a point where the nail sticker has the maximum thickness before applying a pressure. Specifically, when the pressure is applied, a force of 38.5 N is downwardly applied to an area with a size corresponding to 40% to 80% of the entire size of the upper surface of the nail sticker in the atmosphere of a temperature of 36° C.

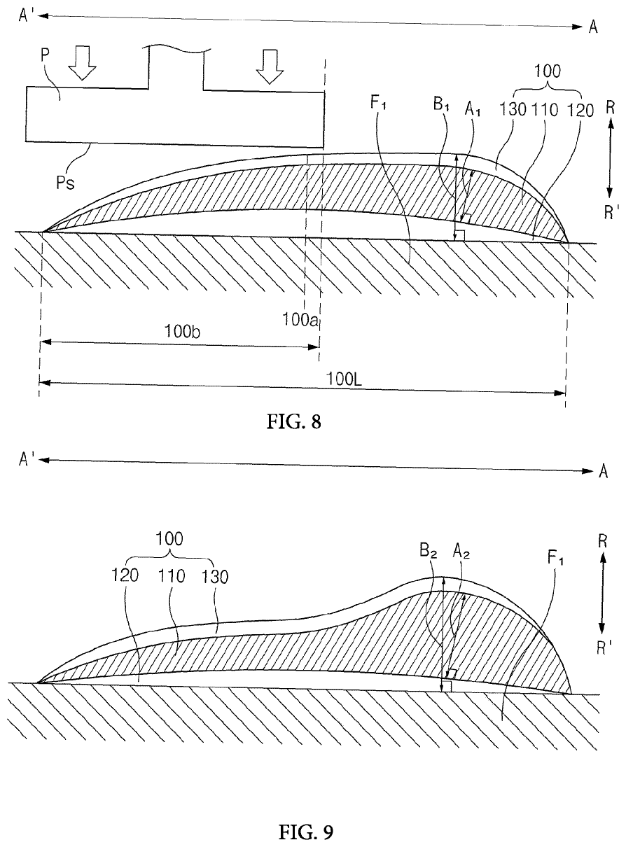

FIG. 8 is a view that the pressure is applied and FIG. 30 is a view of a contact state of a lower surface of the member which applies a pressure and an upper surface of the nail sticker as seen from the top.

Referring to FIGS. 8 and 30, the pressure is not directly applied to the point where the soft layer 110 has the maximum thickness A1 and the point where the nail sticker 100 has the maximum thickness A2. In other words, the pressure is applied to a part Q of the upper surface of the nail sticker and the part Q of the upper surface does not include the point where the nail sticker has the maximum thickness and the point where the nail sticker has the maximum thickness.

This will be described in more detail below. The nail sticker 100 is disposed on a flat floor F1. The nail sticker 100 has an asymmetric structure in the length direction. In other words, the thickness of the nail sticker 100 may be asymmetric in the length direction.

When the pressure is applied, a lower surface Ps of the member P which applies the pressure touches onto the area denoted by 100b of FIG. 8.

For example, the member P which applies the pressure applies the pressure to a point (an area denoted by 100b of FIG. 8) spaced apart from one distal end 100g (a distal end toward a cuticle of the nail when the nail sticker is attached) of the nail sticker 100 by a distance corresponding to 70% of a length 100L of the nail sticker 100 from the distal end. Referring to FIG. 30, an area where the lower surface Ps of the member P which applies the pressure and the upper surface of the nail sticker 100 meet is formed toward the one distal end 100g from a point spaced apart from one distal end 100g of the nail sticker by a distance corresponding to 70% of the length 100L of the nail sticker 100. The other distal end 100h is located in an opposite direction of one distal end and is close to a free edge of the nail.

Here, “attach” means that the nail sticker is disposed on the floor such that the lower surface of the nail sticker and the upper surface of the flat floor are in contact and specifically, means an act of allowing the adhesive layer of the nail sticker to be adhere onto the upper surface of the floor. Further, the floor may be a marble floor and a substrate having an upper surface larger than an area of the lower surface of the nail sticker is considered as the floor.

The nail sticker includes a soft layer of the above-described exemplary embodiment so that after attaching the nail sticker to the nail, when a pressure is applied to a part of the upper surface of the nail sticker, the soft layer below a part of the upper surface applied with the pressure is pushed to an adjacent area. Referring to FIGS. 7 and 8, after placing the nail sticker of FIG. 7 on the flat floor, when the pressure is applied as illustrated in FIG. 8, a maximum thickness of an area other than the area applied with the pressure is increased. Therefore, a thickness of at least a part of the soft layer located below the other part of the upper surface to which the pressure is not applied is increased. This is because materials which configure the soft layer correspond to materials having the above-described property. Therefore, the maximum thickness of the nail sticker is increased.

As described above, when the pressure is applied to a part of the upper surface of the nail sticker, the maximum thickness of the soft layer is increased and the maximum thickness of the nail sticker is increased during this process. The user may apply a pressure to a part of the upper surface of the nail sticker to move a part of the soft layer toward the tip (a free edge direction) of the nail after attaching the nail sticker on the nail. Accordingly, a part of the soft layer moves toward the tip of the nail sticker so that the soft layer fills a space floated between the nail and the nail sticker and the filled state is effectively maintained. Accordingly, the user will feel less a foreign body sensation and the adhesive strength of the nail sticker is increased. Further, when a part of the nail sticker extends beyond a nail area, the soft layer may serve to support the part of the nail sticker which extends and protrudes so as not to be deformed. Further, even though a nail surface has irregularity, more soft layer may be disposed on a recessed portion of the nail surface by applying a predetermined force. Accordingly, even though the nail surface has irregularities, the surface of the attached nail sticker has a smooth shape, which improves aesthetics.

In the nail sticker, a thickness increase rate of the soft layer according to the following Equation 1 is 2% or higher. Specifically, the thickness increase rate of the soft layer may be 3% or higher and more specifically, 3% to 30%, and for example, 5% to 20%.

Thickness increase rate of soft layer=[(A₂−A₁)/A₁]×100 [Equation 1]

A₁ is a maximum thickness of the soft layer measured when the pressure is not applied to the nail sticker attached to the floor and A₂ is a maximum thickness of the soft layer measured after applying the pressure for 3 seconds, removing the pressure, and then leaving the nail sticker for 30 minutes. Specifically, when the pressure is applied, a force of 38.5 N is applied to an area with a size corresponding to 40% to 80% of the entire size of the upper surface of the nail sticker in the atmosphere of a temperature of 36° C.

When the pressure is applied, a force of 38.5 N is applied to the upper surface of the nail sticker in the atmosphere of a temperature of 36° C. The pressure is applied using push gage equipment of IMADA Inc. and a pressure value is measured. An area of the lower surface of the member which applies the pressure may be for example, 177 mm², but is not limited thereto. Further, the pressure is not applied to 1) a point where the soft layer has the maximum thickness before applying a pressure and 2) a point where the nail sticker has the maximum thickness before applying a pressure. Specifically, when the pressure is applied, a force of 38.5 N is downwardly applied in an area with a size corresponding to 40% to 80%, specifically, 50% to 70% and for example, 60% of the entire size of the upper surface of the nail sticker in the atmosphere of a temperature of 36° C.

FIG. 8 is a view that the pressure is applied and FIG. 30 is a view of a contact state of a lower surface of the member which applies a pressure and an upper surface of the nail sticker.

Referring to FIGS. 8 and 30, the pressure is not directly applied to the point where the soft layer 110 has the maximum thickness A₁ and the point where the nail sticker 100 has the maximum thickness A₂. In other words, the pressure is applied to a part of the upper surface of the nail sticker and the part of the upper surface does not include the point where the nail sticker has the maximum thickness and the point where the nail sticker has the maximum thickness.

This will be described in more detail below. The nail sticker 100 is disposed on a flat floor F1. The nail sticker 100 has an asymmetric structure in the length direction. In other words, the thickness of the nail sticker 100 may be asymmetric in the length direction.

When the pressure is applied, a lower surface Ps of the member P which applies the pressure touches onto the area denoted by 100b of FIG. 8.

For example, the member P which applies the pressure applies the pressure to a point spaced apart from one distal end 100g of the nail sticker 100 (a distal end toward a cuticle of the nail when the nail sticker is attached) by a distance corresponding to 70% a length 100L of the nail sticker 100 from the distal end. Referring to FIG. 30, an area where the lower surface Ps of the member P which applies the pressure and the upper surface of the nail sticker 100 meet is formed toward the one distal end 100g from a point spaced apart from one distal end 100g of the nail sticker by a distance corresponding to 70% of the length 100L of the nail sticker 100.

Here, “attach” means that the nail sticker is disposed on the floor such that the lower surface of the nail sticker and the upper surface of the flat floor are in contact and specifically, means an act of allowing the adhesive layer of the nail sticker to be adhered to the upper surface of the floor. Further, the floor may be a marble floor and a substrate having an upper surface larger than an area of the lower surface of the nail sticker is considered as the floor.

Here, the nail sticker is the same as the above-described nail sticker. The soft layer, the coating layer, and the base layer of the above-described nail sticker may be included in the nail sticker of this exemplary embodiment in the same way.

When a range of the thickness increase rate of the soft layer is satisfied, it means that when the pressure is applied to the upper surface of the nail sticker, the soft layer moves in the nail sticker so that the maximum thickness of the soft layer is increased and even though the pressure is removed, the deformed soft layer effectively maintains its shape. Referring to FIGS. 7 and 8, after placing the nail sticker of FIG. 7 on the flat floor, when the pressure is applied as illustrated in FIG. 8, a maximum thickness of an area other than the area applied with the pressure is increased. Further, when the nail sticker of the present invention is seen from the length direction of the nail sticker (a cross-section confirmed along A-A′ of FIG. 4), a point where the soft layer has the maximum thickness before applying the pressure is biased to one distal end of the nail sticker so that the thickness of the nail sticker is asymmetric in the length direction of the nail sticker. In this case, when the pressure is applied to the center of the upper surface of the nail sticker, most of the soft layer in the nail sticker moves to one direction so that an area adjacent to one distal end of the nail sticker has the maximum thickness, which is larger than the maximum thickness before applying the pressure. Further, as illustrated in FIG. 9, even though the pressure is removed and the nail sticker is left for a predetermine time, the deformed nail sticker does not easily return to its original shape.

The effect of the physical property of the nail sticker is as follows.

When the pressure is applied to a part of the upper surface of the nail sticker as described above, the maximum thickness of the soft layer is increased so that the user may attach the nail sticker on the nail and then applies the pressure to the part of the upper surface of the nail sticker to move a part of the soft layer toward the tip (a free edge direction) of the nail. Here, when the maximum thickness is increased, it does not mean that the thickness of an area to which the pressure is applied is increased, but it means that the largest thickness of the soft layer, among thicknesses of the other areas, other than the area to which the pressure is applied, is increased. Further, the point at which the maximum thickness appears before and after applying pressure may also be different.

Accordingly, a part of the soft layer moves toward the tip of the nail sticker so that the soft layer fills a space floated between the nail and the nail sticker and the filled state is effectively maintained. Accordingly, the user will feel less a foreign body sensation and the adhesive strength of the nail sticker is increased. Further, when a part of the nail sticker extends beyond a nail area, the soft layer may serve to support the part of the nail sticker which extends and protrudes so as not to be deformed. Further, even though a nail surface has irregularity, more soft layer may be disposed on a recessed portion of the nail surface by applying a predetermined force. Accordingly, even though the nail surface has irregularities, the surface of the attached nail sticker has a smooth shape, which improves aesthetics. Further, when the range of the thickness increase rate of the soft layer is satisfied, it means that the above-described effects are consistently maintained while the user uses the nail.

The nail sticker according to another exemplary embodiment of the present invention is a curable nail sticker and the nail sticker includes a soft layer. When the nail sticker is attached to a flat bottom and then a pressure is applied to a part of the upper surface of the nail sticker, the maximum thickness of the nail sticker is increased. Here, the nail sticker is the same as the above-described nail sticker. The soft layer, the coating layer, and the base layer of the above-described nail sticker may be included in the nail sticker of this exemplary embodiment in the same way.

The condition that the pressure is applied is the same as described with regard to Equation 1 in the nail sticker according to the above-described exemplary embodiment, so that the description will be omitted.

The nail sticker includes a soft layer of the above-described exemplary embodiment so that after attaching the nail sticker to the nail, when a pressure is applied to a part of the upper surface of the nail sticker, the soft layer below a part of the upper surface applied with the pressure is pushed to an adjacent area. Referring to FIGS. 7 and 8, after placing the nail sticker of FIG. 7 on the flat floor, when the pressure is applied as illustrated in FIG. 8, a maximum thickness of an area other than the area applied with the pressure is increased. Therefore, a thickness of at least a part of the soft layer located below the other part of the upper surface to which the pressure is not applied is increased. This is because materials which configure the soft layer correspond to materials having the above-described property. Therefore, the maximum thickness of the nail sticker is increased.

As described above, when the pressure is applied to a part of the upper surface of the nail sticker, the maximum thickness of the soft layer is increased and the maximum thickness of the nail sticker is increased during this process. The user may apply a pressure to a part of the upper surface of the nail sticker to move a part of the soft layer toward the tip (a free edge direction) of the nail after attaching the nail sticker on the nail. Accordingly, a part of the soft layer moves toward the tip of the nail sticker so that the soft layer fills a space floated between the nail and the nail sticker and the filled state is effectively maintained. Accordingly, the user will feel less a foreign body sensation and the adhesive strength of the nail sticker is increased. Further, when a part of the nail sticker extends beyond a nail area, the soft layer may serve to support the part of the nail sticker which extends and protrudes so as not to be deformed. Further, even though a nail surface has irregularity, more soft layer may be disposed on a recessed portion of the nail surface by applying a predetermined force. Accordingly, even though the nail surface has irregularities, the surface of the attached nail sticker has a smooth shape, which improves aesthetics.

In the nail sticker, a thickness increase rate of the nail sticker according to the following Equation 2 is 2% or higher. Specifically, the thickness increase rate of the nail sticker may be 3% or higher and more specifically, 3% to 30%, and for example, 5% to 20%.

Increase rate of nail sticker=[(B₂−B₁)/B₁]×100 [Equation 2]

B₁ is a maximum thickness of the nail sticker measured when the pressure is not applied to the nail sticker attached to the floor and B₂ is a maximum thickness of the nail sticker measured after applying the pressure for 3 seconds, removing the pressure, and then leaving the nail sticker for 30 minutes. The pressure is applied to an area corresponding to 40% to 80% of the entire area of the upper surface of the nail sticker with a force of 38.5 N in the atmosphere of a temperature of 36° C.

Here, the nail sticker is the same as the above-described nail sticker. The soft layer, the coating layer, and the base layer of the above-described nail sticker may be included in the nail sticker of this exemplary embodiment in the same way. The condition that the pressure is applied is the same as described with regard to Equation 1 in the nail sticker according to the above-described exemplary embodiment, so that the description will be omitted.

When a range of the thickness increase rate of the nail sticker is satisfied, it means that when the pressure is applied to the upper surface of the nail sticker, the soft layer moves in the nail sticker so that the maximum thickness of the soft layer is increased and even though the pressure is removed, the deformed soft layer effectively maintains its shape. Referring to FIGS. 7 and 8, after placing the nail sticker of FIG. 7 on the flat floor, when the pressure is applied as illustrated in FIG. 8, a maximum thickness of an area other than the area applied with the pressure is increased. Further, when the nail sticker of the present invention is seen from the length direction of the nail sticker (a cross-section confirmed along A-A′ of FIG. 4), a point where the soft layer has the maximum thickness before applying the pressure is biased to one distal end of the nail sticker so that the thickness of the nail sticker is asymmetric in the length direction of the nail sticker. In this case, when the pressure is applied to the center of the upper surface of the nail sticker, it is understood that most of the soft layer in the nail sticker moves to one direction so that an area adjacent to one distal end of the nail sticker has the maximum thickness, which is larger than the maximum thickness before applying the pressure. Further, as illustrated in FIG. 9, even though the pressure is removed and the nail sticker is left for a predetermine time, the deformed nail sticker does not easily return to its original shape.

The effect of the physical property of the nail sticker is as follows.

When the pressure is applied to a part of the upper surface of the nail sticker as described above, the maximum thickness of the soft layer is increased so that the user may attach the nail sticker on the nail and then applies the pressure to the part of the upper surface of the nail sticker to move a part of the soft layer toward the tip (a free edge direction) of the nail. Here, when the maximum thickness is increased, it does not mean that the thickness of an area to which the pressure is applied is increased, but it means that the largest thickness of the soft layer, among thicknesses of the other areas, other than the area to which the pressure is applied, is increased. Further, the point at which the maximum thickness appears before and after applying pressure may also be different.

Accordingly, a part of the soft layer moves toward the tip of the nail sticker so that the soft layer fills a space floated between the nail and the nail sticker and the filled state is effectively maintained. Accordingly, the user will feel less a foreign body sensation and the adhesive strength of the nail sticker is increased. Further, when a part of the nail sticker extends beyond a nail area, the soft layer may serve to support the part of the nail sticker which extends and protrudes so as not to be deformed. Further, even though a nail surface has irregularity, more soft layer may be disposed on a recessed portion of the nail surface by applying a predetermined force. Accordingly, even though the nail surface has irregularities, the surface of the attached nail sticker has a smooth shape, which improves aesthetics. Further, when the range of the thickness increase rate of the soft layer is satisfied, it means that the above-described effects are consistently maintained while the user uses the nail.

A nail sticker according to still another exemplary embodiment of the present invention is curable and includes a soft layer. A rectangular parallelepiped substrate with a thickness of 0.7 mm disposed on a flat floor is prepared and the nail sticker is attached on an upper surface of the substrate such that an area having a length corresponding to 70% of the entire length of the nail sticker is in contact with the flat upper surface of the substrate. When measuring after a force of 38.5 N is applied to at least a part of the upper surface of the nail sticker which overlaps the substrate in a vertical direction toward a floor, the force is removed and then the nail sticker is left for 30 minutes at 36° C., a shortest distance between an area where a part of the nail sticker which does not overlap the substrate in the vertical direction and protrudes out of the substrate is in contact with the floor and the substrate is 1.5 mm or less. The force is applied to an area corresponding to 40% to 80% of the entire area of the upper surface of the nail sticker. Specifically, the shortest distance D satisfies 0 mm to 1.3 mm, and more specifically, 0 mm to 1.0 mm.

Here, the soft layer may be the same as the soft layer which has been described in the nail sticker of the above-described exemplary embodiment and the nail sticker is also the same as the nail sticker of the above-described exemplary embodiment. Accordingly, all configurations described in the above-described nail sticker, such as the base layer, the soft layer, and the coating layer have the same as the configurations of the nail sticker of the present exemplary embodiment.

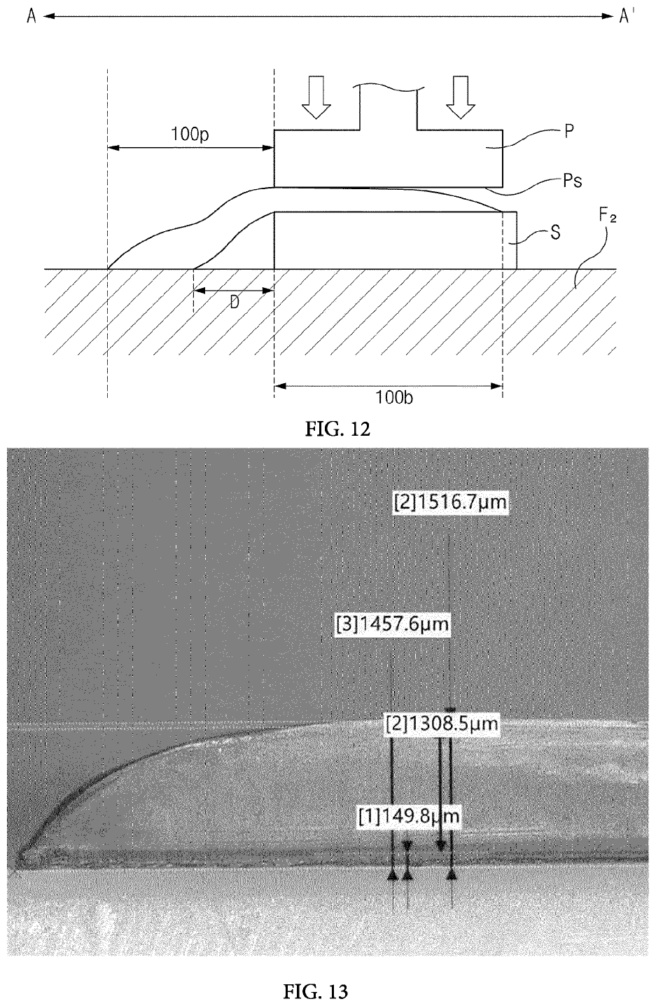

The above-contents will be described with reference to FIG. 12 as follows. A substrate S is disposed on a flat floor F. The substrate S may be a rectangular parallelepiped and the substrate S may have a predetermined thickness T and the thickness is 0.7 mm. A part of the nail sticker 100 is attached onto the substrate S to overlap the substrate S in a vertical direction H. At this time, a length of the part of the nail sticker 100 is 70% of the entire length of the nail sticker 100. Referring to FIG. 2, the entire length refers to the longest length of the nail sticker in the A-A′ direction and a length of the part of the nail sticker 100 refers to a length of a part of the entire length of the nail sticker in the A-A′ direction. As described above, when the part of the nail sticker 100 is attached on the substrate S, a part 100p of the nail sticker 100 does not overlap the substrate S and protrudes out of the substrate S and the length of the protruding part 100p may be 30% of the entire length of the nail sticker. At this time, the protruding part 100p has an area which is bent toward the floor F to be in contact with the floor F. When measuring after removing the pressure and leaving the nail sticker for 30 minutes at 36° C., the shortest distance D between the area and the substrate S can be measured. In the meantime, before applying the pressure, a point where the nail sticker 100 has the maximum thickness may belong to the protruding part 100p. The force is applied to an area corresponding to 40% to 80%, specifically, 50% to 70%, and for example, 60% of the entire area of the upper surface of the nail sticker.

When the force is applied, a force of 38.5 N is applied to a part of the upper surface of the nail sticker in the atmosphere of a temperature of 36° C. The pressure is applied using push gage equipment of IMADA Inc. and a pressure value is measured. An area of the lower surface of the member which applies the pressure may be for example, 177 mm², but is not limited thereto.

The characteristic that the shortest distance D is 1.5 mm or less can be achieved because the nail sticker includes the soft layer. When the pressure is applied to the upper surface of the nail sticker, the soft layer in the nail sticker is deformed to partially move to the floor. Therefore, in a state in which the shortest distance D is not excessively large, the protruding part 100p may be in contact with the floor F.

The characteristic has a significant effect in a process of attaching the nail sticker to the nail of the user. That is, when the user applies a predetermined force during the process of attaching the nail sticker 100 to the nail, a space between the nail and the nail sticker is effectively filled with the soft layer. Accordingly, the contamination of the nail sticker due to the foreign material is reduced, the user may feel less foreign body sensation, and the adhesive strength of the nail sticker is further improved. Further, when a part of the nail sticker extends beyond a nail area, the soft layer may serve to support the part of the nail sticker which extends and protrudes so as not to be deformed. Further, even though the nail surface has irregularities, the surface of the attached nail sticker has a smooth shape, which improves aesthetics.

In contrast, if the shortest distance D is too large, exceeding 1.5 mm, it means that it is difficult for the soft layer to be deformed, so that even though the user applies a predetermined amount of force in the process of attaching the nail sticker 100 to the nail, it is difficult for the soft layer to fill the lifted space between the nail and nail sticker. Further, it is difficult to move the soft layer, so that the irregularities of the nail surface are reflected on the surface of the nail sticker as it is so that the surface of the nail sticker also has a uneven shape. Furthermore, the shape of the nail sticker is easily deformed.

Hereinafter, preferred examples will be provided in order to assist in the understanding of the present invention, but it will be obvious that the following examples are only illustrative of the present invention and various modifications and alternations may be made within the scope and technical idea of the present invention and also it will be natural that these modifications and alterations may fall within the scope of the appended claims, to those skilled in the art.

### EXAMPLES AND COMPARATIVE EXAMPLE

### Example 1

A nail sticker including a base layer (a thickness is 150 μm), a soft layer (maximum thickness is 1380.3 μm) disposed on the base layer, and a coating layer (maximum thickness is 65 μm) disposed on the soft layer was prepared. The base layer included an adhesive layer (maximum thickness is 50 μm) and a printed layer (maximum thickness is 100 μm) disposed on the adhesive layer. The adhesive layer configured the lower surface of the nail sticker.

The soft layer included 60 wt % of cellulose acetate butyrate which was a resin for a soft layer, 38 wt % of urethane acrylate oligomer which was an UV curing raw material for a soft layer, and 2 wt % of phenylbis(2,4,6-trimethylbenzoyl)phosphine which was a photoinitiator for a soft layer.

The coating layer included urethane acrylate which was an UV curing raw material for a coating layer and phenylbis(2,4,6-trimethylbenzoyl)phosphine which was a resin for a coating layer.

### Comparative Example 1

A nail sticker including a base layer (thickness is 150 μm), a first coating layer (maximum thickness is 1182.6 μm) disposed on the base layer, and a second coating layer (maximum thickness is 65 μm) disposed on the first coating layer was prepared. The base layer included an adhesive layer (maximum thickness is 50 μm) and a printed layer (maximum thickness is 100 μm) disposed on the adhesive layer. The adhesive layer configured the lower surface of the nail sticker.

The first coating layer included 60 wt % of nitrocellulose as a resin for the first coating layer, 38 wt % of urethane acrylate oligomer as an ultraviolet curing raw material for the first coating layer, and 2 wt % of phenylbis(2,4,6-)trimethylbenzoyl)phosphine oxide as a photoinitiator for the first coating layer.

The second coating layer included urethane acrylate as an ultraviolet curing raw material for the second coating, phenylbis(2,4,6-trimethylbenzoyl)phosphine oxide as a photoinitiator for the second coating layer, and nitrocellulose as a resin for the second coating layer.

### Experimental Example 1

The physical properties for the nail stickers of Example 1 and Comparative Example 1 were confirmed as follows.

A rectangular parallelepiped substrate with a thickness of 0.7 mm disposed on a flat floor is prepared and a part of the nail sticker is attached on an upper surface of the substrate such that an area having a length corresponding to 70% the entire length of the nail sticker is in contact with the flat upper surface of the substrate. After applying a force of 38.5 N to an area (an area corresponding to 60% of the entire area of the upper surface of the nail sticker) in which the nail sticker and the substrate overlapped in a vertical direction for 3 seconds in the atmosphere of a temperature of 36° C., the pressure was removed and then the nail sticker was left for 30 minutes at 36° C. Thereafter, a shortest distance between an area in which a part of the nail sticker which did not overlap the substrate in the vertical direction and protruded out of the substrate was in contact with the floor and the substrate was measured.

FIG. 28 is a photographs obtained by capturing an experiment result of Example 1 and FIG. 29 is a photographs obtained by capturing an experiment result of Comparative Example 1.

TABLE 1

| | Shortest distance (mm) |
|---|---|
| Example 1 | 0.845 |
| Comparative Example 1 | 3.617 |

### Experimental Example 2

The following experiment was conducted on the nail stickers of Example 1 and Comparative Example 1.

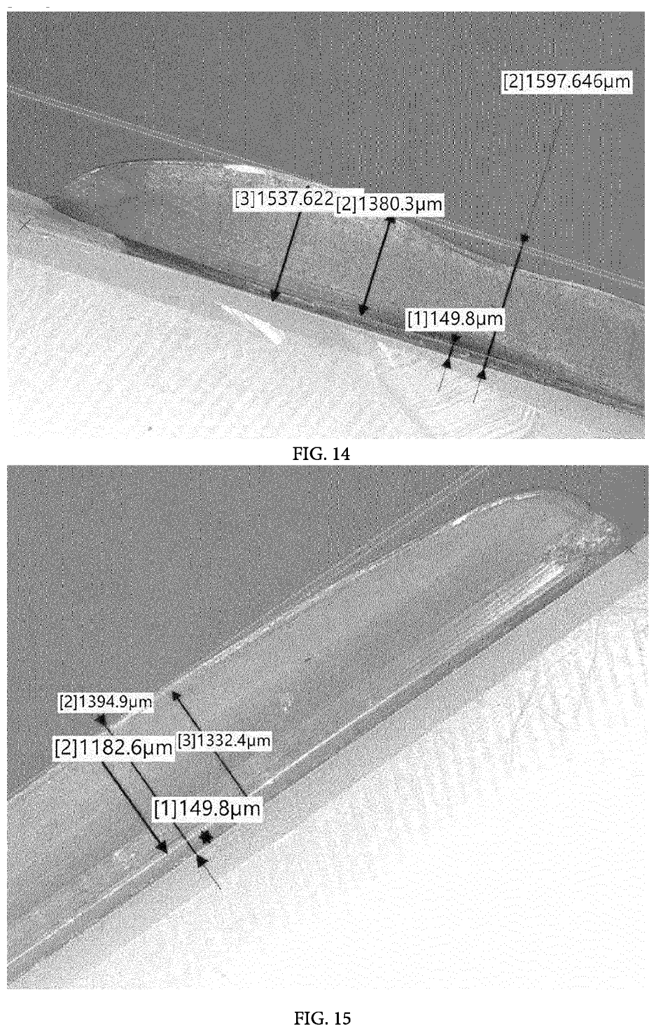

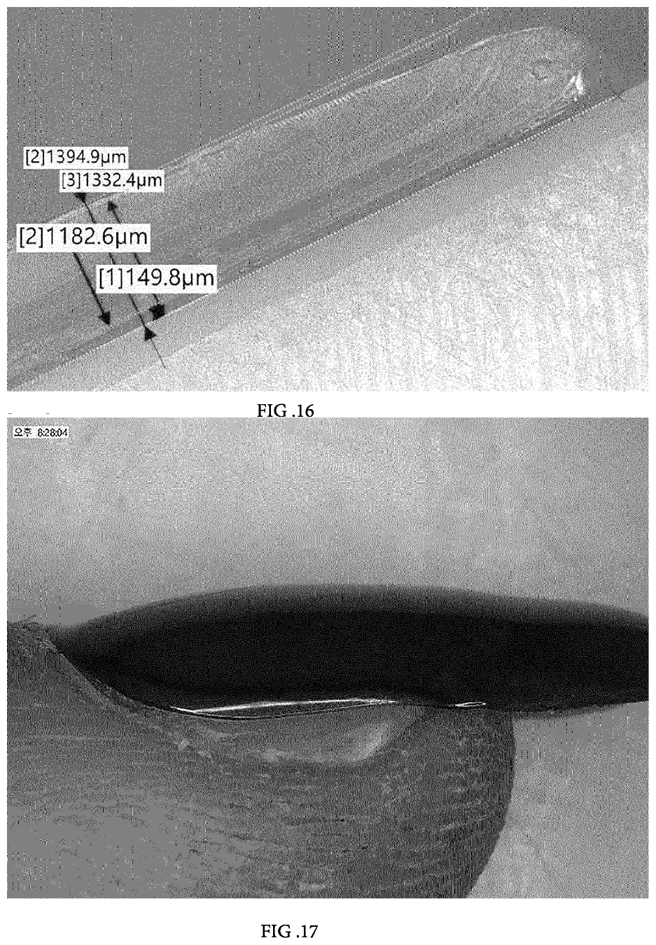

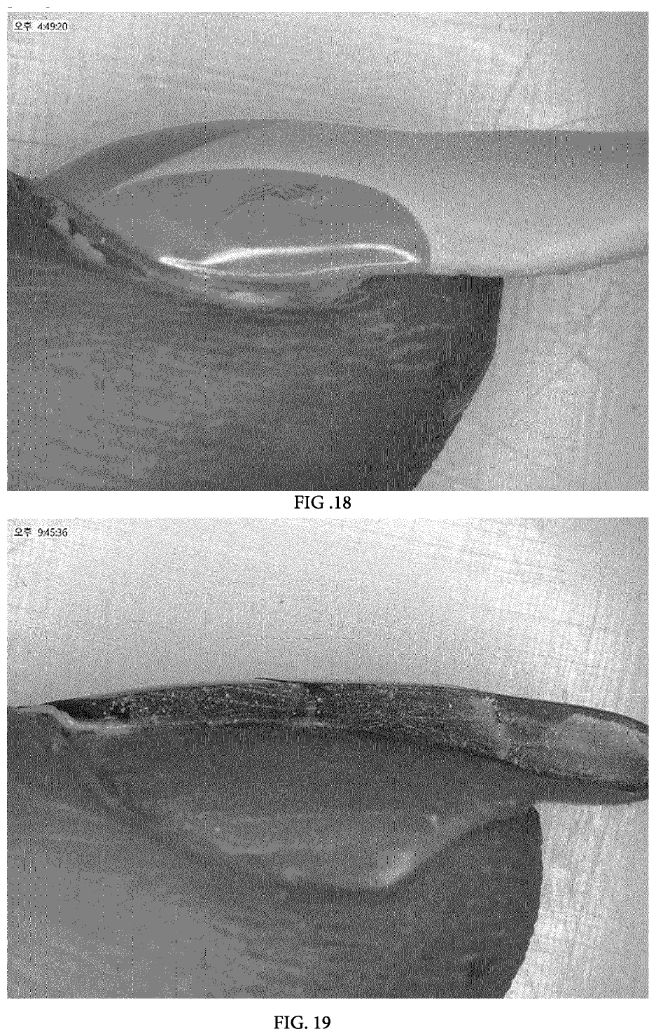

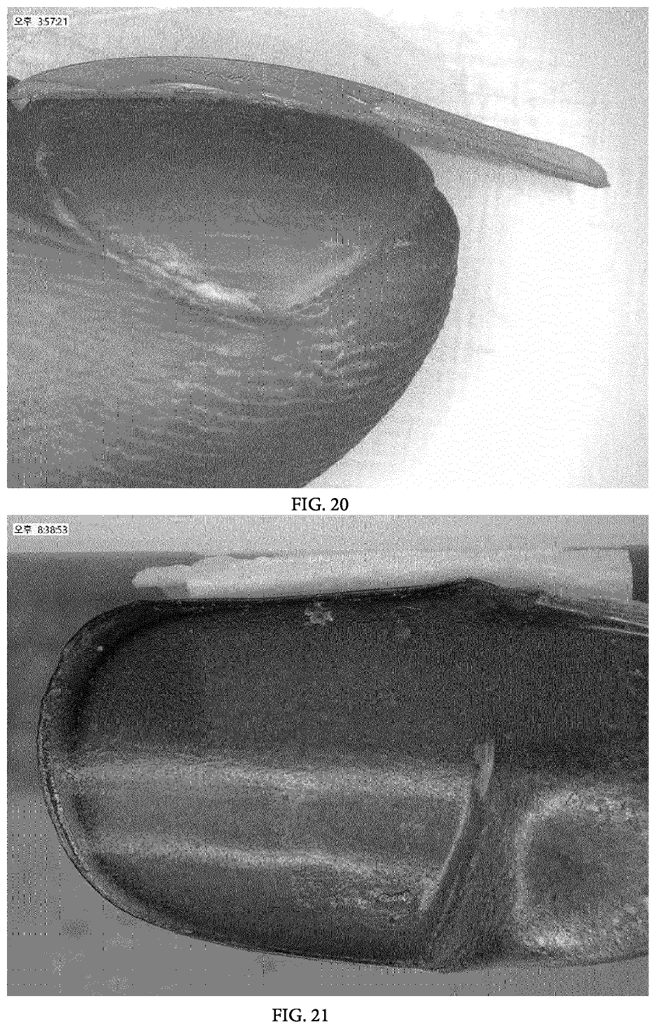

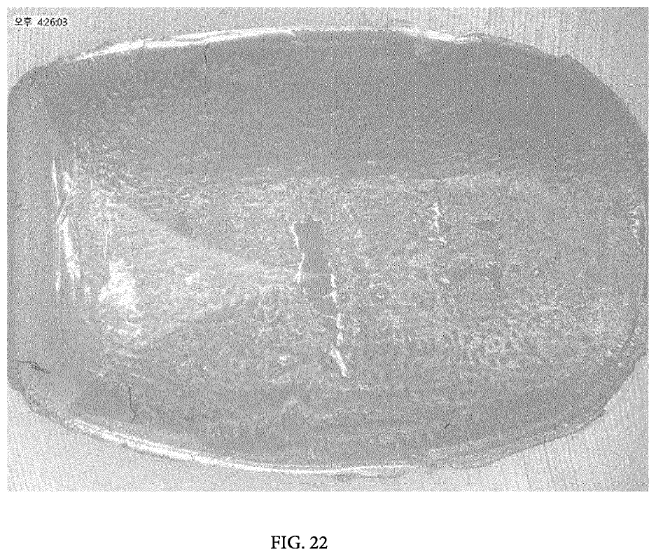

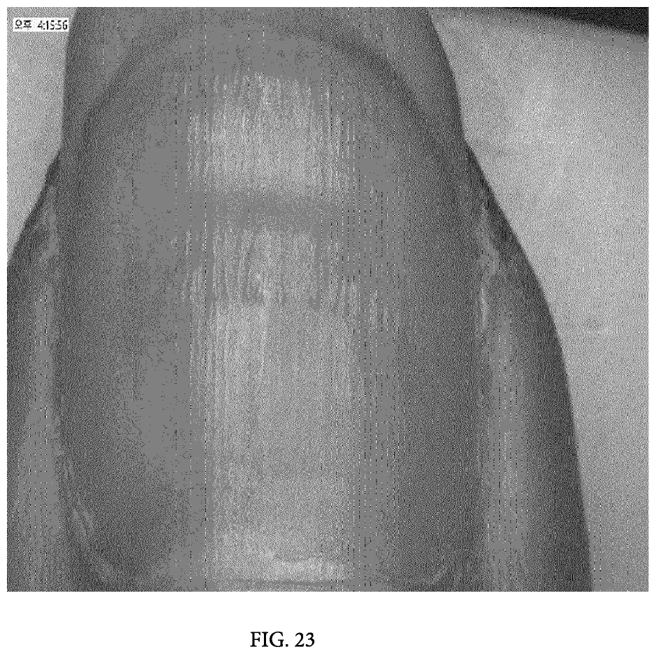

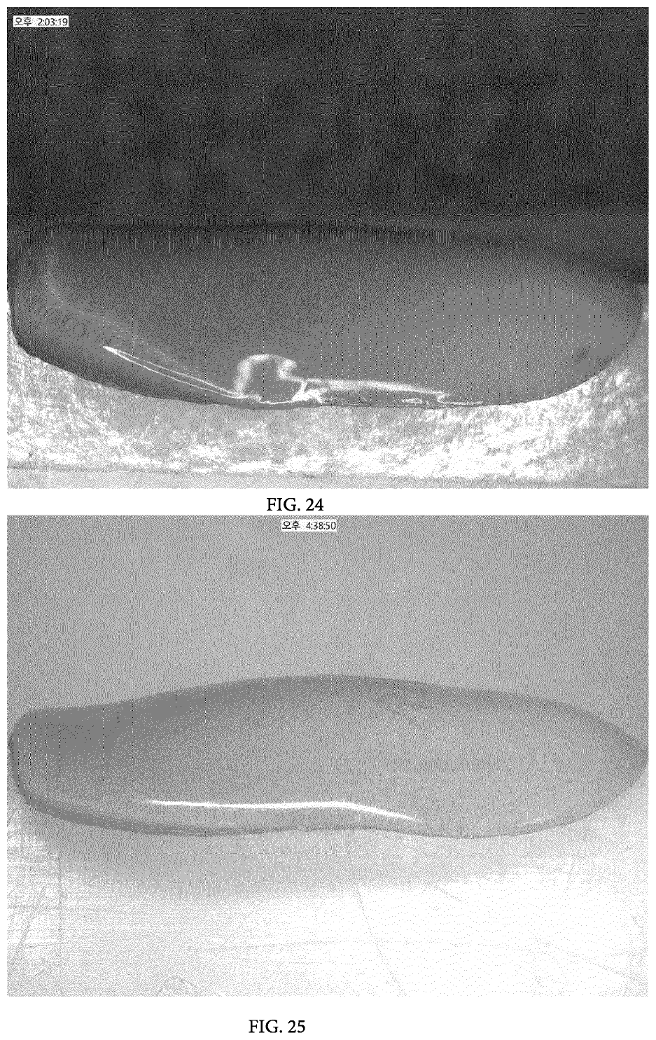

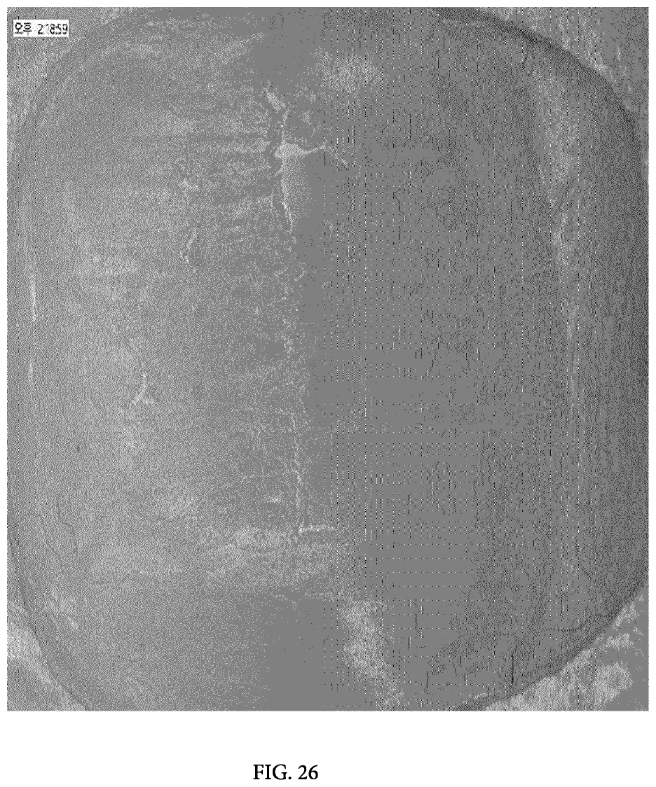

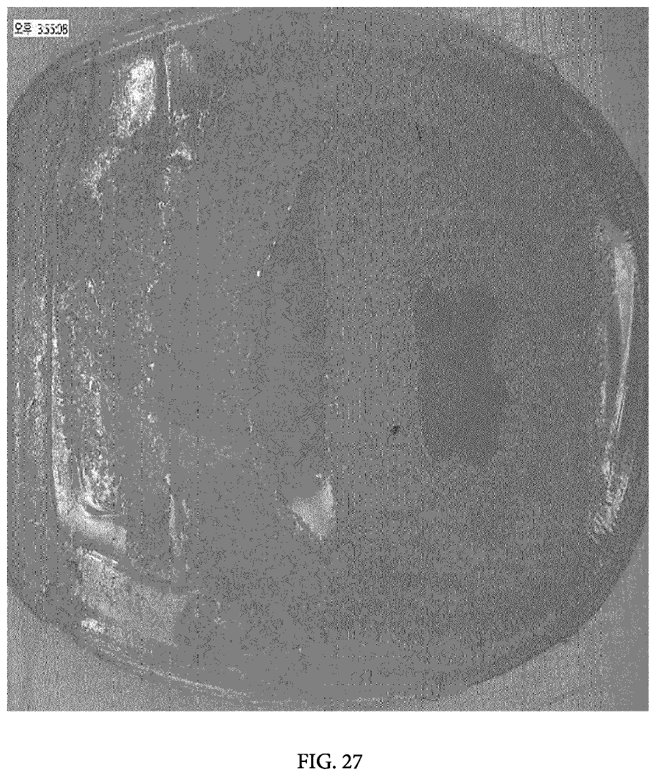

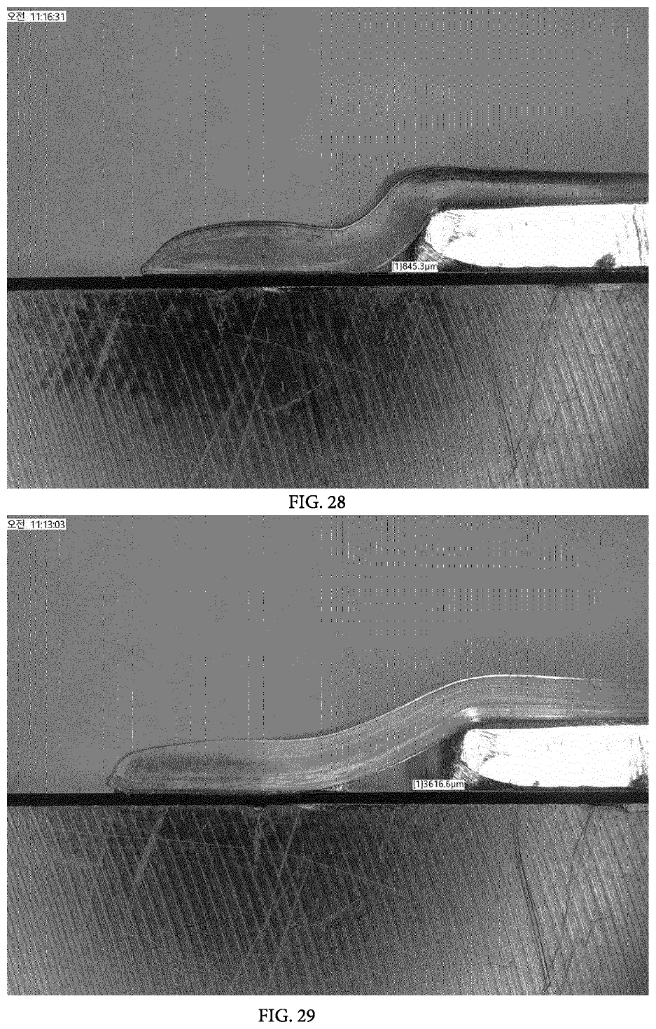

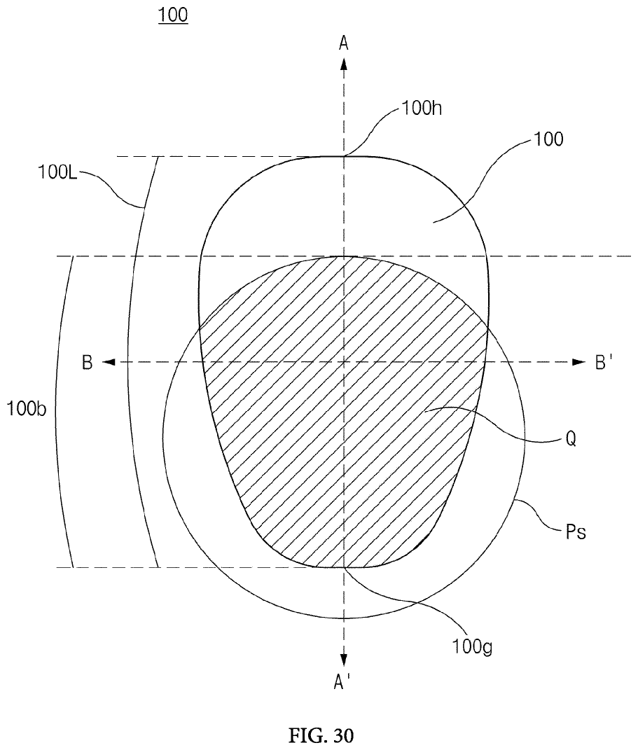

FIG. 13 is a cross-sectional photograph before applying a pressure in a state in which the adhesive layer of the nail sticker is attached on an upper surface of the flat floor such that the lower surface of the nail sticker of Example 1 faces the upper surface of the flat floor. FIG. 14 is a cross-sectional photograph captured when after applying a force of 38.5 N to a part (an area which corresponds to 60% of the entire area of the upper surface, but does not include a point where the thicknesses of the nail sticker and the soft layer are maximum) of the upper surface of the nail sticker using a pressure member having a lower surface (circular) with an area of 177 mm² with respect to the nail sticker of Example 1 attached on the floor as illustrated in FIG. 13, in the atmosphere of a temperature of 36° C., the force is removed and the nail sticker is left for 30 minutes in the atmosphere of a temperature of 36° C. The cross sections of FIGS. 13 and 14 correspond to the cross-section of the nail sticker taken along the A-A′ of FIG. 4. The maximum thickness measured through FIGS. 13 and 14 and the thickness change rate information were represented in Table 2.

Comparative Example 1 was measured in the same way and the result was represented in Table 2. FIG. 15 is a cross-sectional photograph before applying a pressure in a state in which the adhesive layer of the nail sticker is attached on an upper surface of the flat floor such that the lower surface of the nail sticker of Comparative Example 1 faces the upper surface of the flat floor. FIG. 16 is a cross-sectional photograph captured after applying a pressure in the same condition as described above, removing the pressure, and then leaving the nail sticker.

TABLE 2

| | | | Comparative Example 1 | |
|---|---|---|---|---|
| | Example 1 | | First coating | |
| | Soft layer | Nail sticker | layer | Nail sticker |
| Maximum | A₁: 1308.5 | B₁: 1516.7 | A₁: 1182.6 | B₁: 1394.9 |
| thickness (μm) | | | | |
| before applying | | | | |
| pressure | | | | |
| Maximum | A₂: 1380.3 | B₂: 1597.6 | A₂: 1182.6 | B₂: 1394.9 |
| thickness (μm) | | | | |
| after removing | | | | |
| pressure and | | | | |
| then being left | | | | |
| for | | | | |
| predetermined | | | | |
| time | | | | |
| Thickness | 5.49 | 5.33 | 0 | 0 |
| increase rate | | | | |
| (%) | | | | |

The thickness increase rate of the soft layer was calculated as follows.

Thickness increase rate of soft layer (%)=[(A₂−A₁)/A₁]×100 [Equation 1]

A₁ is a maximum thickness of the soft layer measured when the pressure is not applied to the nail sticker attached to the floor and A₂ is a maximum thickness of the soft layer measured after applying the pressure for 3 seconds, removing the pressure, and then leaving the nail sticker for 30 minutes. The pressure is applied to an area corresponding to 60% of the entire area of the upper surface of the nail sticker with a force of 38.5 N in the atmosphere of a temperature of 36° C. When Equation 1 is applied to Comparative Example 1, the first coating layer of Comparative Example 1 corresponds to the soft layer of Example 1.

The thickness increase rate of the nail sticker was calculated as follows.

Thickness increase rate of nail sticker=[(B₂−B₁)/B₁]×100 [Equation 2]

B₁ is a maximum thickness of the nail sticker measured when the pressure is not applied to the nail sticker attached to the floor and B₂ is a maximum thickness of the nail sticker measured after applying the pressure for 3 seconds, removing the pressure, and then leaving the nail sticker for 30 minutes. The pressure is applied to an area corresponding to 60% of the entire area of the upper surface of the nail sticker with a force of 38.5 N in the atmosphere of a temperature of 36° C.

### Experimental Example 3

The experiment was conducted on the nail stickers of Example 1 and Comparative Example 1 as follows.

After placing the nail sticker on a ridged nail surface so that the wavy nail surface was in contact with the lower surface (a surface through which the adhesive layer is exposed) of the nail sticker, a predetermined force was applied with a finger to attach the nail sticker on the nail. Thereafter, under the conditions of a light quantity of 1800 mmJ/cm² or more, an output of 6 W, and a rated voltage of 5 V/1.2 A, ultraviolet rays with a wavelength of 395 nm were irradiated twice for 45 seconds to cure the nail sticker.

This was illustrated in FIG. 17 (a nail sticker of Example 1) and FIG. 18 (a nail sticker of Comparative Example 1).

Referring to FIG. 17, it is known that the surface of the nail sticker is smooth without dents. In contrast, referring to FIG. 18, it is known that a part of the area located on the vicinity of the tip of the nail, of the surface of the nail sticker is recessed. That is, in Example 1, a part of the soft layer moves to the tip of the nail during the process of attaching the nail sticker on the nail so that the thickness of the soft layer in the vicinity of the nail tip is increased and the thickened soft layer serves to prevent a space between the nail and the nail sticker.

This can be more surely confirmed from FIG. 19 (a cross-section of a nail sticker of Example 1) and FIG. 20 (a cross-section of a nail sticker of Comparative Example 1). Referring to FIG. 19, it is understood that the nail sticker of Example 1 is closely attached to the nail as much as possible in an area which overlaps the nail in the vertical direction. Specifically, the thickness is increased toward the tip of the nail to maintain a contact state with the nail. This is because the soft layer in the nail sticker moves to be leaned to the tip of the nail to consistently maintain the contact state of the nail sticker and the nail. In contrast, referring to FIG. 20, it is understood that the nail sticker of Comparative Example 1 is not attached to the nail in the vicinity of the tip of the nail.

### Experimental Example 4

In the meantime, with respect to Example 1 and Comparative Example 1, after attaching and curing the nail sticker under the same condition as Experimental Example 1, the nail sticker was removed and a lower surface of the nail sticker was observed. FIG. 21 is a lower surface of a nail sticker of Example 1 and FIG. 22 is a lower surface of a nail sticker of Comparative Example 1.

Referring to FIG. 21, in Example 1, it is understood that the soft layer moves toward the nail tip so that a part of the nail sticker which is thicker than the peripheral portion in the middle is formed like a nail line. Therefore, it is understood that the nail and the nail sticker are effectively contacted by this parts and the shape of the nail sticker is maintained. In contrast, referring to FIG. 22, in the nail sticker of Comparative Example, a thick portion of the lower surface generated by the movement of the layer was not observed.

### Experimental Example 5

FIG. 23 is a photograph of a fingernail with a severe ridge on a surface. Specifically, the upper surface of the nail of FIG. 13 includes a convex portion.

The nail stickers of Example 1 and Comparative Example were attached to the nail of FIG. 23 and cured under the same condition as Experimental Example 1.

Referring to FIG. 24, it is understood that even though the ridge of the nail surface is severe, the irregularities do not appear on the upper surface of the nail sticker of Example 1. This is because the soft layer effectively moves in the nail sticker of Example 1 (see the cross-sectional view of FIG. 11) so that the soft layer is deformed to allow the surface of the nail sticker to have a smooth shape.

In contrast, referring to FIG. 25, in the case of the nail sticker of Comparative Example 1 which does not include a soft layer, there is a problem in that the ridge of the nail surface appears on the upper surface of the nail sticker as it is. Specifically, the upper surface of the nail sticker of FIG. 25 has a convex area corresponding to the convex portion of the nail upper surface.

### Experimental Example 6

FIG. 23 is a photograph of a nail with a severe ridge on a surface.

The nail stickers of Example 1 and Comparative Example were attached to the nail of FIG. 23 and cured under the same condition as Experimental Example 1. Thereafter, the nail sticker was removed and then the lower surface was observed.

Referring to FIG. 27, in the case of the nail sticker of Comparative Example 1, it is difficult for the lower surface of the nail sticker to be in contact with the recessed area of the nail so that a smooth area of the adhesive layer partially remains in a partial area of the lower surface of the nail sticker spaced apart from the nail surface as it is (an area which is not smooth means that when the nail and the adhesive layer come into contact with each other, adhesive components of the adhesive layer aggregate together to form a net).

In contrast, referring to FIG. 26, in the case of the nail sticker of Example 1, it is understood that as the soft layer moves, the lower surface of the nail sticker effectively fills the recessed area of the nail so that there is no smooth area on the lower surface of the nail sticker.

### EXPLANATION OF REFERENCE NUMERALS AND SYMBOLS

1: Nail sticker of related art
2: Nail
3: Finger
100: Nail sticker
110: Soft layer
120: Base layer
130: Coating layer
S: Substrate
F1, F2: Floor

1. A curable nail sticker, comprising:
a soft layer,
wherein the soft layer includes a resin for the soft layer, and the resin for the soft layer includes at least one of cellulose acetate butyrate and cellulose acetate propionate.

2. The nail sticker according to claim 1, wherein the resin for the soft layer is included in the soft layer in an amount of 10 wt % to 90 wt %.

3. The nail sticker according to claim 1, wherein the soft layer is cured by irradiating ultraviolet ray.

4. The nail sticker according to claim 1, wherein the soft layer further includes a ultraviolet curing material for the soft layer.

5. The nail sticker according to claim 4, wherein the ultraviolet curing material for the soft layer is included in the soft layer in an amount of 10 wt % to 90 wt %.

6. The nail sticker according to claim 1, further comprising:
a base layer,
wherein the soft layer is disposed on the base layer.

7. The nail sticker according to claim 1, further comprising:
a coating layer,
wherein the coating layer is disposed on the soft layer.

8. The nail sticker according to claim 7, wherein the coating layer includes an ultraviolet curing material for the coating layer and a resin for the coating layer.

9. The nail sticker according to claim 1, wherein the nail sticker is cured when the ultraviolet ray is irradiated.

10. A curable nail sticker, comprising:
a soft layer,
wherein a maximum thickness of the soft layer is increased when a pressure is applied to a part of an upper surface of the nail sticker after attaching the nail sticker on a flat floor.

11. The nail sticker according to claim 10, wherein a thickness increase rate of the soft layer according to Equation 1 is 2% or higher.
Thickness increase rate of soft layer=[(A₂−A₁)/A₁]×100 [Equation 1]
A₁ is a maximum thickness of the soft layer measured when the pressure is not applied to the nail sticker attached to the floor and A₂ is a maximum thickness of the soft layer measured after applying the pressure for 3 seconds, removing the pressure, then leaving the nail sticker for 30 minutes in the atmosphere of a temperature of 36° C., and as the pressure, a force of 38.5 N is downwardly applied to an area with a size corresponding to 40% to 80% of the entire size of the upper surface of the nail sticker in the atmosphere of a temperature of 36° C.

12. A curable nail sticker, comprising:
a soft layer,
wherein a maximum thickness of the nail sticker is increased when a pressure is applied to a part of an upper surface of the nail sticker after attaching the nail sticker on a flat floor.

13. The nail sticker according to claim 12, wherein a thickness increase rate of the nail sticker according to Equation 2 is 2% or higher
Thickness increase rate of nail sticker=[(B₂−B₁)/B₁]×100 [Equation 2]
B₁ is a maximum thickness of the nail sticker measured when the pressure is not applied to the nail sticker attached to the floor and B₂ is a maximum thickness of the nail sticker measured after applying the pressure for 3 seconds, removing the pressure, then leaving the nail sticker for 30 minutes in the atmosphere of a temperature of 36° C., and as the pressure, a force of 38.5 N is downwardly applied to an area with a size corresponding to 40% to 80% of the entire size of the upper surface of the nail sticker in the atmosphere of a temperature of 36° C.

14. A curable nail sticker, comprising:
a soft layer,
wherein a rectangular parallelepiped substrate with a thickness of 0.7 mm disposed on a flat floor is prepared and the nail sticker is attached on an upper surface such that an area having a length corresponding to 70% the entire length of the nail sticker is in contact with the flat upper surface of the substrate, when measuring after a force of 38.5 N is applied to at least a part of the upper surface of the nail sticker which overlaps the substrate in a vertical direction toward a floor, the force is removed and then the nail sticker is left for 30 minutes at 36° C., a shortest distance between an area where a part of the nail sticker which does not overlap the substrate in the vertical direction and protrudes out of the substrate is in contact with the floor and the substrate is 1.5 mm or less, and
the force is applied to an area corresponding to 40% to 80% the entire area of the upper surface of the nail sticker.
